(19) United States
(12) Patent Application Publication
(10) Pub. No.: US 2019/0147226 A1
(43) Pub. Date: May 16, 2019

(54) METHOD, SYSTEM AND APPARATUS FOR MATCHING A PERSON IN A FIRST IMAGE TO A PERSON IN A SECOND IMAGE

(71) Applicant: CANON KABUSHIKI KAISHA, Tokyo (JP)

(72) Inventors: Ben Yip, Ryde (AU); Geoffrey Richard Taylor, Carlingford (AU); Rajanish Calisa, Artarmon (AU)

(21) Appl. No.: 15/811,347

(22) Filed: Nov. 13, 2017

(51) Int. Cl. G06K 9/00; G06K 9/46

(52) U.S. Cl. CPC G06K 9/00288; G06K 9/4661; G06K 9/00228; G06K 9/00677

(57) ABSTRACT

A method of matching a first person in a first image to a person in a second image. At least one companion in the first image is determined and being different to the first person. A contextual confidence for the first person, the companion and each of a plurality of people in the second image is determined, the contextual confidence being a measure of prediction accuracy of a match to the first person. An appearance score between each person in the first image and each of the plurality of people in the second image, the appearance score measuring similarity of appearance. The method selects from the plurality of people in the second image, a match for the first person and, based on the match for the first person, a match for the companion, each of the matches being determined according to the contextual confidence and appearance score.

### TECHNICAL FIELD

The present invention relates generally to image processing and, in particular, to the problem of person re-identification. The present invention also relates to a method and apparatus for matching a person in a first image to a person in a second image, and to a computer program product including a computer readable medium having recorded thereon a computer program for matching a person in a first image to a person in a second image.

### BACKGROUND

Public venues such as shopping centres, parking lots and train stations are increasingly subject to surveillance using large-scale networks of video cameras. Application domains of large-scale video surveillance include security, safety, traffic management and business analytics. In one example application from the security domain, a security officer may want to view any video feed containing a particular suspicious person in order to identify undesirable activities. In another example from the business analytics domain, a shopping centre may wish to track customers across multiple cameras in order to build a profile of shopping habits. In the following discussion, the terms “person”, “target”, “probe” and “object” will be understood to mean an object of interest that may be within view of a video surveillance camera.

Many surveillance applications require methods, known as “video analytics”, to detect, track, match and analyse multiple objects across multiple camera views. In one example, also called “hand-off”, object matching is used to persistently track multiple objects across a first and second camera with overlapping fields of view. In another example, also called “re-identification”, object matching is used to locate a specific object of interest across multiple cameras in the network with non-overlapping fields of view.

A “region” or “image region” in an image, refers to a collection of one or more spatially adjacent visual elements. A “feature”, “appearance descriptor” or “descriptor” represents a derived value or set of derived values determined from the pixel values in an image region. One example of a feature is a histogram of colour values in the image region. Another example is a histogram of quantized image gradient responses in a region.

A known method for analysing an object in an image includes the steps of detecting a bounding box containing the object and extracting an appearance descriptor of the object from pixels within the bounding box. The term “bounding box” refers to a rectilinear region of the image containing an object, and an “appearance descriptor” refers to a set of values derived from the pixels. One example of an appearance descriptor is a histogram of pixel colours within a bounding box. Another example of an appearance descriptor is a histogram of image gradients within a bounding box. Another example of an appearance descriptor is a histogram of image gradients within a bounding box.

Robust person re-identification is a challenging problem for several reasons. Firstly, many people may have similar appearance, such as a crowd of commuters on public transport wearing similar business attire. Secondly, the person may be occluded by stationery objects, or moving objects, such as another person. Thirdly, lighting, shadows and other photometric properties including focus, contrast, brightness and white balance can vary significantly between cameras and locations. In one example, a single network may simultaneously include outdoor cameras viewing objects in bright daylight, and indoor cameras viewing objects under artificial lighting.

One person re-identification method addresses the blurriness issue, where a video segment containing the probe person is taken as an input. A frame from the video segment that has the least blurriness to perform person re-identification is selected. However, if the probe person is affected by other factors such as lighting conditions, that issue is not addressed.

Another person re-identification method addresses the occlusion issue, by taking one image containing the probe person (commonly known as the probe image) as an input. A non-occluded portion of the probe person is then manually selected, and only the selected portion is used in person re-identification. However, the non-occluding part cannot be too small or have issues such as image blur and lighting affecting the non-occluding part.

The task of person re-identification may be extended to group re-identification. Given an image (the probe image) of a target group of people, the group of people is located in other cameras over the network. An image from another camera over the network is commonly known as a gallery image.

One method of person re-identification summarises the probe image into a descriptor, holistically without addressing each individual in the group. This descriptor is then used to seek a similar descriptor that summarized other gallery images. However, appearance, occlusion, and bad lighting may effect this method which summarises the probe image into a descriptor.

Another method of person re-identification uses group information to aid person re-identification. When in the probe image, the probe person is part of a group and holds a spatial position relative to the group. Then, it is assumed that the probe person would also hold a similar spatial position relative to the group in the gallery image. The spatial position is then used to aid person re-identification. However, people in the group often still have issues like similar appearance, occlusion, and bad lighting.

### SUMMARY

It is an object of the present invention to substantially overcome, or at least ameliorate, one or more disadvantages of existing arrangements.

Disclosed are arrangements which use the concept of contextual confidence to aid person re-identification. Contextual confidence of a first person in a first image is a measure of “confidence”, “prediction accuracy” or “reliability” of a re-identification outcome of the particular person in a gallery image (i.e., a second image), within the context of the gallery image. For a probe person in the probe image, contextual confidence of the probe person is a measure of prediction accuracy of the probe person being re-identified in the gallery image (i.e., a match to the probe person being determined in the gallery image). For example, a person has lower contextual confidence if the person is dressed similar to other people in a gallery image, than a person dressed very distinctively to others in the gallery image. As another example, a person wearing a white coat has lower contextual confidence than a person wearing a red coat in a hospital. However, the same person wearing a white coat has high contextual confidence in a business district where most people might be wearing black (or dark) suites.

In still another example, a person has a lower contextual confidence value if the person is occluded and only part of the person is visible, than someone whose entire person is visible in the image. When a larger portion of a person is visible, there is a higher probability of correct re-identification.

In still another example, a person has a lower contextual confidence value if the person is standing in a dark area, where much of the colour of the appearance of the person is hard to identify, than a person who is well lighted and the colours of the appearance of the person are nice and clear in the image.

To perform person re-identification of a person in an image that has low contextual confidence is challenging. The disclosed arrangements use a “companion” (i.e., a person who companioning the low contextual confidence person), to aid person re-identification. The person re-identification is more accurate when both the low contextual confidence person and the companion are considered together. For example, re-identifying a white dressed person in a hospital is more accurate if the white dressed person is walking along with a very distinctively dressed person, and the same distinctively dressed person is also in the gallery image.

According to one aspect of the present disclosure, there is provided a method of matching a first person in a first image to a person in a second image, the method comprising:

determining at least one companion in the first image, the companion being one of a plurality of people in the first image and being different to the first person;

determining a contextual confidence for the first person, the companion and each of a plurality of people in the second image, the contextual confidence being a measure of prediction accuracy of a match to the first person;

determining an appearance score between each person in the first image and each of the plurality of people in the second image, the appearance score measuring similarity of appearance; and

selecting from the plurality of people in the second image, a match for the first person and, based on the match for the first person, a match for the companion, each of the matches being determined according to the contextual confidence and appearance score.

According to another aspect of the present disclosure, there is provided an apparatus for matching a first person in a first image to a person in a second image, the apparatus comprising:

means for determining at least one companion in the first image, the companion being one of a plurality of people in the first image and being different to the first person;

means for determining a contextual confidence for the first person, the companion and each of a plurality of people in the second image, the contextual confidence being a measure of confidence of a match to the first person;

means for determining an appearance score between each person in the first image and each of the plurality of people in the second image, the appearance score measuring similarity of appearance; and

means for selecting from the plurality of people in the second image, a match for the first person and, based on the match for the first person, a match for the companion, each of the matches being determined according to the contextual confidence and appearance score.

According to still another aspect of the present disclosure, there is provided a system for matching a first person in a first image to a person in a second image, the system comprising:

a memory for storing data and a computer program;

a processor coupled to the memory for executing the computer program, the computer program having instructions for:
determining at least one companion in the first image, the companion being one of a plurality of people in the first image and being different to the first person;
determining a contextual confidence for the first person, the companion and each of a plurality of people in the second image, the contextual confidence being a measure of confidence of a match to the first person;
determining an appearance score between each person in the first image and each of the plurality of people in the second image, the appearance score measuring similarity of appearance; and
selecting from the plurality of people in the second image, a match for the first person and, based on the match for the first person, a match for the companion, each of the matches being determined according to the contextual confidence and appearance score.

According to still another aspect of the present disclosure, there is provided a non-transitory computer readable medium having program stored on the medium for matching a first person in a first image to a person in a second image, the program comprising:

code for determining at least one companion in the first image, the companion being one of a plurality of people in the first image and being different to the first person;

code for determining a contextual confidence for the first person, the companion and each of a plurality of people in the second image, the contextual confidence being a measure of confidence of a match to the first person;

code for determining an appearance score between each person in the first image and each of the plurality of people in the second image, the appearance score measuring similarity of appearance; and

code for selecting from the plurality of people in the second image, a match for the first person and, based on the match for the first person, a match for the companion, each of the matches being determined according to the contextual confidence and appearance score.

Other aspects are also disclosed.

### BRIEF DESCRIPTION OF THE DRAWINGS

One or more embodiments of the invention will now be described with reference to the following drawings, in which:

FIG. 1 is a flow diagram showing a method of matching a probe person in a probe image to a person in a gallery image;

FIG. 2 is a flow diagram showing a method of selecting a person in the gallery image who matches a probe person in a probe image;

FIG. 3A shows a probe image containing three people including a probe person and a companion person;

FIG. 3B shows the probe image of FIG. 3A indicated by a bounding box;

FIG. 3C shows the probe image of FIG. 3A with a number of questions displayed on the image about the probe person;

FIG. 4A shows the probe image of FIG. 3A where the companion person is indicated by a bounding box;

FIG. 4B shows the probe image of FIG. 3A with a number of questions displayed on the image about the companion person;

FIG. 4C shows the probe image of FIG. 3A with a DONE button displayed on the image;

FIG. 5 shows an instance of a user interface for asking questions to determine the contextual confidence of a person;

FIG. 6 shows another instance of a user interface for asking questions to determine the contextual confidence of a person;

FIG. 7 is a flow diagram showing a method of selecting a matching person in the gallery image based on contextual confidences and appearance scores; and

FIGS. 8A and 8B form a schematic block diagram of a general purpose computer system upon which arrangements described can be practiced.

### DETAILED DESCRIPTION INCLUDING BEST MODE

Given a probe person in a first image referred to as a probe image, person re-identification may be used to identify the probe person in a second image referred to as a gallery image. As described in more detail below, contextual confidence of the probe person in the first image is a measure of prediction accuracy of the first person being re-identified in the second image (i.e., a match to probe person being determined in the gallery image).

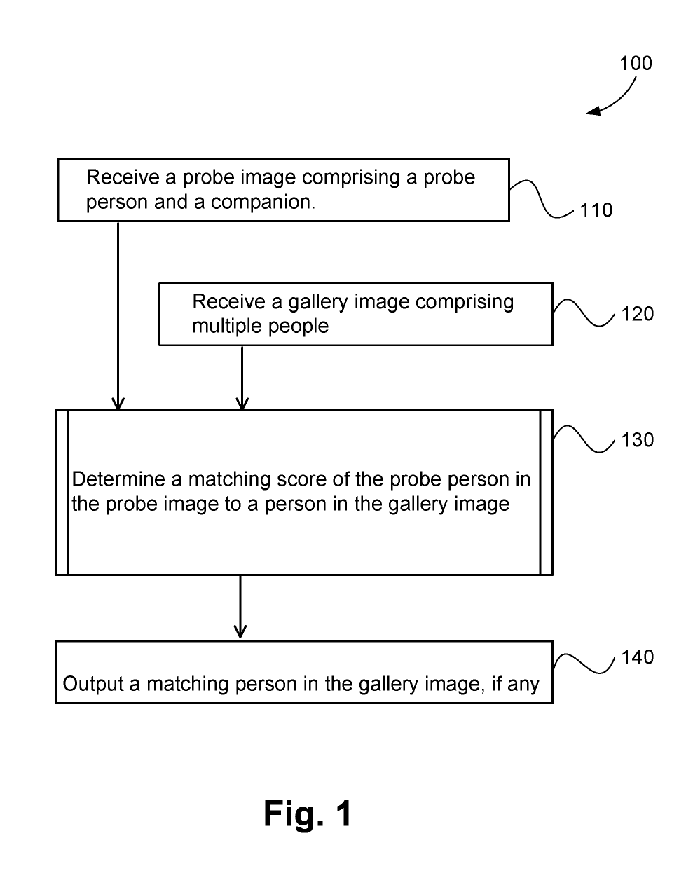

A method 100 of matching a probe person in a probe image to a person in a gallery image will now be described with reference to FIG. 1.

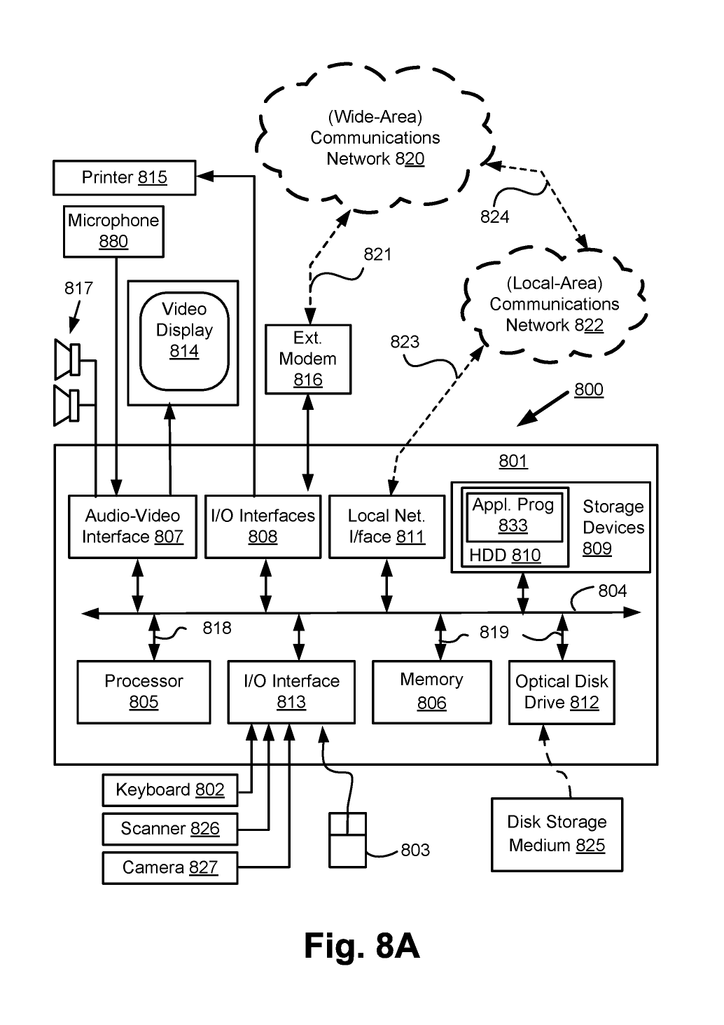

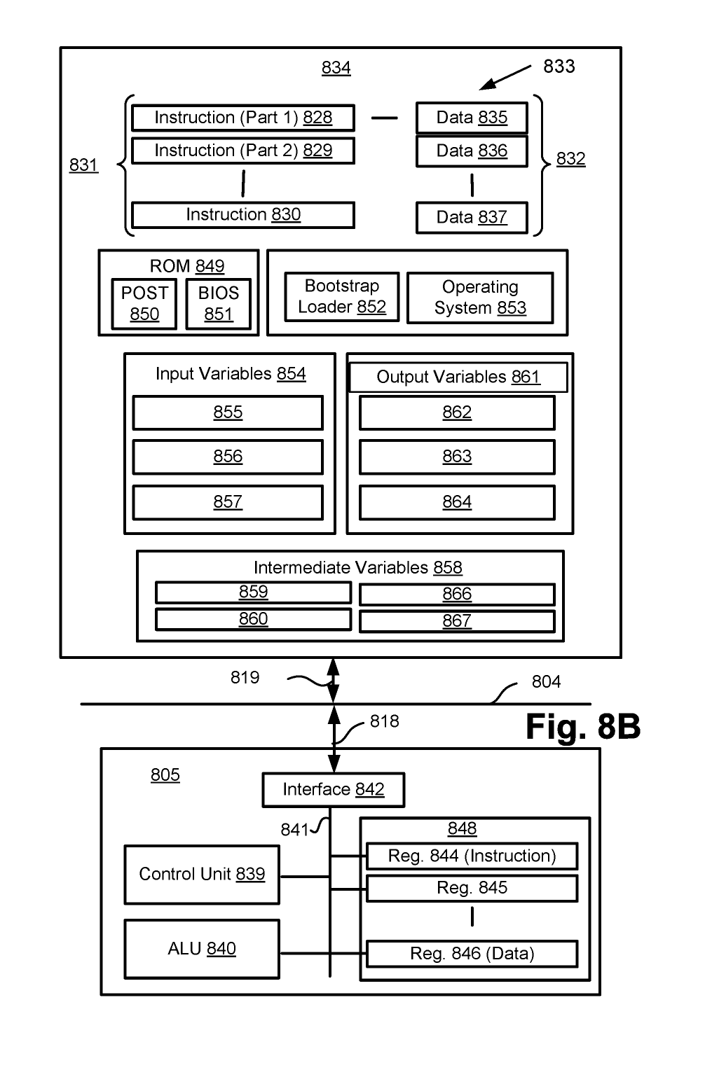

FIGS. 8A and 8B depict a general-purpose computer system 800, upon which the various arrangements described can be practiced.

As seen in FIG. 8A, the computer system 800 includes: a computer module 801; input devices such as a keyboard 802, a mouse pointer device 803, a scanner 826, a camera 827, and a microphone 880; and output devices including a printer 815, a display device 814 and loudspeakers 817. An external Modulator-Demodulator (Modem) transceiver device 816 may be used by the computer module 801 for communicating to and from a communications network 820 via a connection 821. The communications network 820 may be a wide-area network (WAN), such as the Internet, a cellular telecommunications network, or a private WAN. Where the connection 821 is a telephone line, the modem 816 may be a traditional “dial-up” modem. Alternatively, where the connection 821 is a high capacity (e.g., cable) connection, the modem 816 may be a broadband modem. A wireless modem may also be used for wireless connection to the communications network 820.

The computer module 801 typically includes at least one processor unit 805, and a memory unit 806. For example, the memory unit 806 may have semiconductor random access memory (RAM) and semiconductor read only memory (ROM). The computer module 801 also includes an number of input/output (I/O) interfaces including: an audio-video interface 807 that couples to the video display 814, loudspeakers 817 and microphone 880; an I/O interface 813 that couples to the keyboard 802, mouse 803, scanner 826, camera 827 and optionally a joystick or other human interface device (not illustrated); and an interface 808 for the external modem 816 and printer 815. In some implementations, the modem 816 may be incorporated within the computer module 801, for example within the interface 808. The computer module 801 also has a local network interface 811, which permits coupling of the computer system 800 via a connection 823 to a local-area communications network 822, known as a Local Area Network (LAN). As illustrated in FIG. 8A, the local communications network 822 may also couple to the wide network 820 via a connection 824, which would typically include a so-called “firewall” device or device of similar functionality. The local network interface 811 may comprise an Ethernet circuit card, a Bluetooth® wireless arrangement or an IEEE 802.11 wireless arrangement; however, numerous other types of interfaces may be practiced for the interface 811.

The I/O interfaces 808 and 813 may afford either or both of serial and parallel connectivity, the former typically being implemented according to the Universal Serial Bus (USB) standards and having corresponding USB connectors (not illustrated). Storage devices 809 are provided and typically include a hard disk drive (HDD) 810. Other storage devices such as a floppy disk drive and a magnetic tape drive (not illustrated) may also be used. An optical disk drive 812 is typically provided to act as a non-volatile source of data. Portable memory devices, such optical disks (e.g., CD-ROM, DVD, Blu-ray USB-RAM, portable, external hard drives, and floppy disks, for example, may be used as appropriate sources of data to the system 800.

The components 805 to 813 of the computer module 801 typically communicate via an interconnected bus 804 and in a manner that results in a conventional mode of operation of the computer system 800 known to those in the relevant art. For example, the processor 805 is coupled to the system bus 804 using a connection 818. Likewise, the memory 806 and optical disk drive 812 are coupled to the system bus 804 by connections 819. Examples of computers on which the described arrangements can be practised include IBM-PC's and compatibles, Sun Sparcstations, Apple Mac™ or like computer systems.

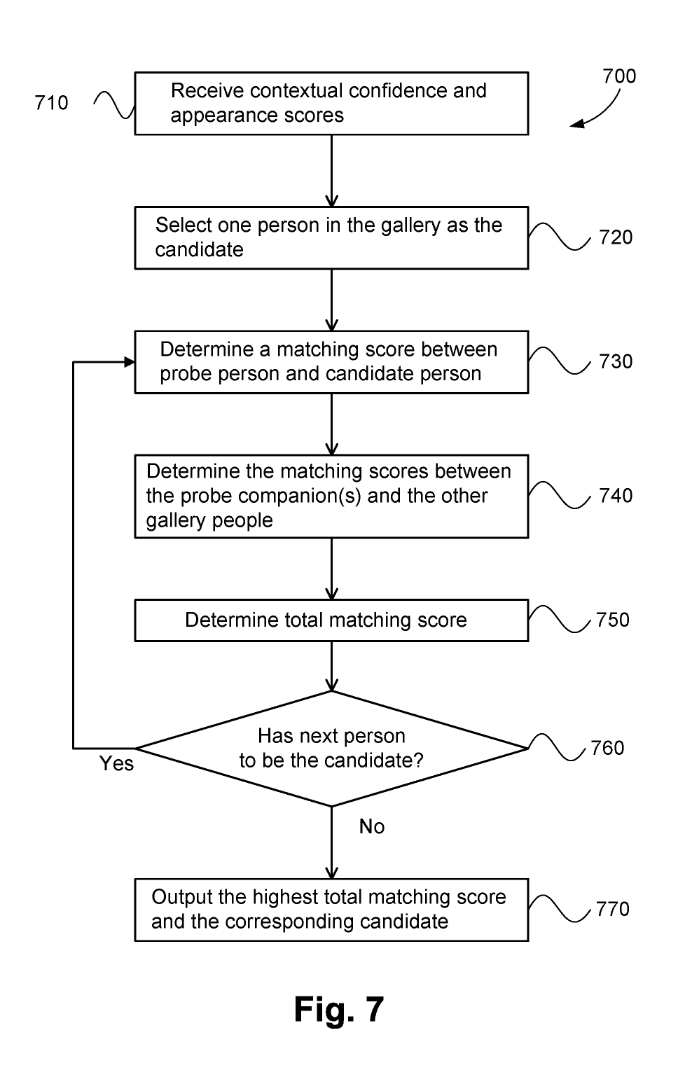

The method 100 and other methods described below may be implemented using the computer system 800 wherein the processes of FIGS. 1, 2 and 7, to be described, may be implemented as one or more software application programs 833 executable within the computer system 800. In particular, the steps of the method 200 are effected by instructions 831 (see FIG. 8B) in the software 833 that are carried out within the computer system 800. The software instructions 831 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software 833 is typically stored in the HDD 810 or the memory 806. The software is loaded into the computer system 800 from the computer readable medium, and then executed by the computer system 800. Thus, for example, the software 833 may be stored on an optically readable disk storage medium (e.g., CD-ROM) 825 that is read by the optical disk drive 812. A computer readable medium having such software or computer program recorded on the computer readable medium is a computer program product. The use of the computer program product in the computer system 800 preferably effects an advantageous apparatus for implementing the described methods.

In some instances, the application programs 833 may be supplied to the user encoded on one or more CD-ROMs 825 and read via the corresponding drive 812, or alternatively may be read by the user from the networks 820 or 822. Still further, the software can also be loaded into the computer system 800 from other computer readable media. Computer readable storage media refers to any non-transitory tangible storage medium that provides recorded instructions and/or data to the computer system 800 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 801. Examples of transitory or non-tangible computer readable transmission media that may also participate in the provision of software, application programs, instructions and/or data to the computer module 801 include radio or infra-red transmission channels as well as a network connection to another computer or networked device, and the Internet or Intranets including e-mail transmissions and information recorded on Websites and the like.

The second part of the application programs 833 and the corresponding code modules mentioned above may be executed to implement one or more graphical user interfaces (GUIs) to be rendered or otherwise represented upon the display 814. Through manipulation of typically the keyboard 802 and the mouse 803, a user of the computer system 800 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 817 and user voice commands input via the microphone 880.

FIG. 8B is a detailed schematic block diagram of the processor 805 and a “memory” 834. The memory 834 represents a logical aggregation of all the memory modules (including the HDD 809 and semiconductor memory 806) that can be accessed by the computer module 801 in FIG. 8A.

When the computer module 801 is initially powered up, a power-on self-test (POST) program 850 executes. The POST program 850 is typically stored in a ROM 849 of the semiconductor memory 806 of FIG. 8A. A hardware device such as the ROM 849 storing software is sometimes referred to as firmware. The POST program 850 examines hardware within the computer module 801 to ensure proper functioning and typically checks the processor 805, the memory 834 (809, 806), and a basic input-output systems software (BIOS) module 851, also typically stored in the ROM 849, for correct operation. Once the POST program 850 has run successfully, the BIOS 851 activates the hard disk drive 810 of FIG. 8A. Activation of the hard disk drive 810 causes a bootstrap loader program 852 that is resident on the hard disk drive 810 to execute via the processor 805. This loads an operating system 853 into the RAM memory 806, upon which the operating system 853 commences operation. The operating system 853 is a system level application, executable by the processor 805, to fulfil various high level functions, including processor management, memory management, device management, storage management, software application interface, and generic user interface.

The operating system 853 manages the memory 834 (809, 806) to ensure that each process or application running on the computer module 801 has sufficient memory in which to execute without colliding with memory allocated to another process. Furthermore, the different types of memory available in the system 800 of FIG. 8A must be used properly so that each process can run effectively. Accordingly, the aggregated memory 834 is not intended to illustrate how particular segments of memory are allocated (unless otherwise stated), but rather to provide a general view of the memory accessible by the computer system 800 and how such is used.

As shown in FIG. 8B, the processor 805 includes a number of functional modules including a control unit 839, an arithmetic logic unit (ALU) 840, and a local or internal memory 848, sometimes called a cache memory. The cache memory 848 typically includes a number of storage registers 844-846 in a register section. One or more internal busses 841 functionally interconnect these functional modules. The processor 805 typically also has one or more interfaces 842 for communicating with external devices via the system bus 804, using a connection 818. The memory 834 is coupled to the bus 804 using a connection 819.

The application program 833 includes a sequence of instructions 831 that may include conditional branch and loop instructions. The program 833 may also include data 832 which is used in execution of the program 833. The instructions 831 and the data 832 are stored in memory locations 828, 829, 830 and 835, 836, 837, respectively. Depending upon the relative size of the instructions 831 and the memory locations 828-830, a particular instruction may be stored in a single memory location as depicted by the instruction shown in the memory location 830. Alternately, an instruction may be segmented into a number of parts each of which is stored in a separate memory location, as depicted by the instruction segments shown in the memory locations 828 and 829.

In general, the processor 805 is given a set of instructions which are executed therein. The processor 805 waits for a subsequent input, to which the processor 805 reacts to by executing another set of instructions. Each input may be provided from one or more of a number of sources, including data generated by one or more of the input devices 802, 803, data received from an external source across one of the networks 820, 802, data retrieved from one of the storage devices 806, 809 or data retrieved from a storage medium 825 inserted into the corresponding reader 812, all depicted in FIG. 8A. The execution of a set of the instructions may in some cases result in output of data. Execution may also involve storing data or variables to the memory 834.

The disclosed arrangements use input variables 854, which are stored in the memory 834 in corresponding memory locations 855, 856, 857. The disclosed arrangements produce output variables 861, which are stored in the memory 834 in corresponding memory locations 862, 863, 864. Intermediate variables 858 may be stored in memory locations 859, 860, 866 and 867.

Referring to the processor 805 of FIG. 8B, the registers 844, 845, 846, the arithmetic logic unit (ALU) 840, and the control unit 839 work together to perform sequences of micro-operations needed to perform “fetch, decode, and execute” cycles for every instruction in the instruction set making up the program 833. Each fetch, decode, and execute cycle comprises:
a fetch operation, which fetches or reads an instruction 831 from a memory location 828, 829, 830;
a decode operation in which the control unit 839 determines which instruction has been fetched; and
an execute operation in which the control unit 839 and/or the ALU 840 execute the instruction.

Thereafter, a further fetch, decode, and execute cycle for the next instruction may be executed. Similarly, a store cycle may be performed by which the control unit 839 stores or writes a value to a memory location 832.

Each step or sub-process in the processes of FIGS. 1, 2 and 7 is associated with one or more segments of the program 833 and is performed by the register section 844, 845, 847, the ALU 840, and the control unit 839 in the processor 805 working together to perform the fetch, decode, and execute cycles for every instruction in the instruction set for the noted segments of the program 833.

The method 100 and the other methods described below may alternatively be implemented in dedicated hardware such as one or more integrated circuits performing the functions or sub functions of the described methods. Such dedicated hardware may include graphic processors, digital signal processors, or one or more microprocessors and associated memories.

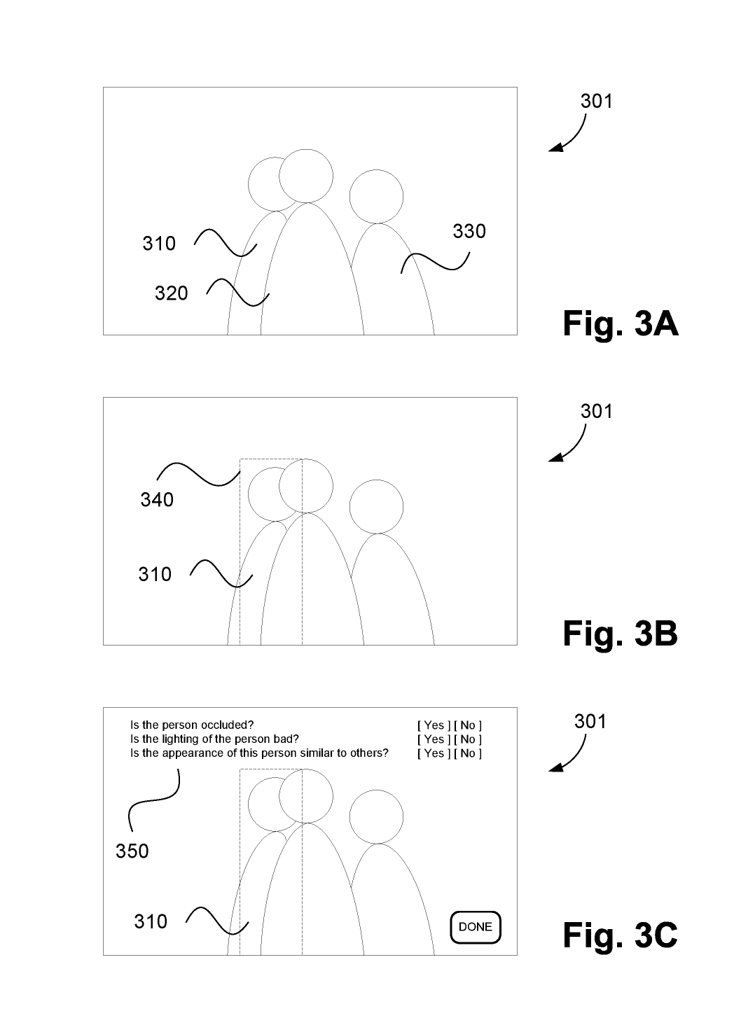

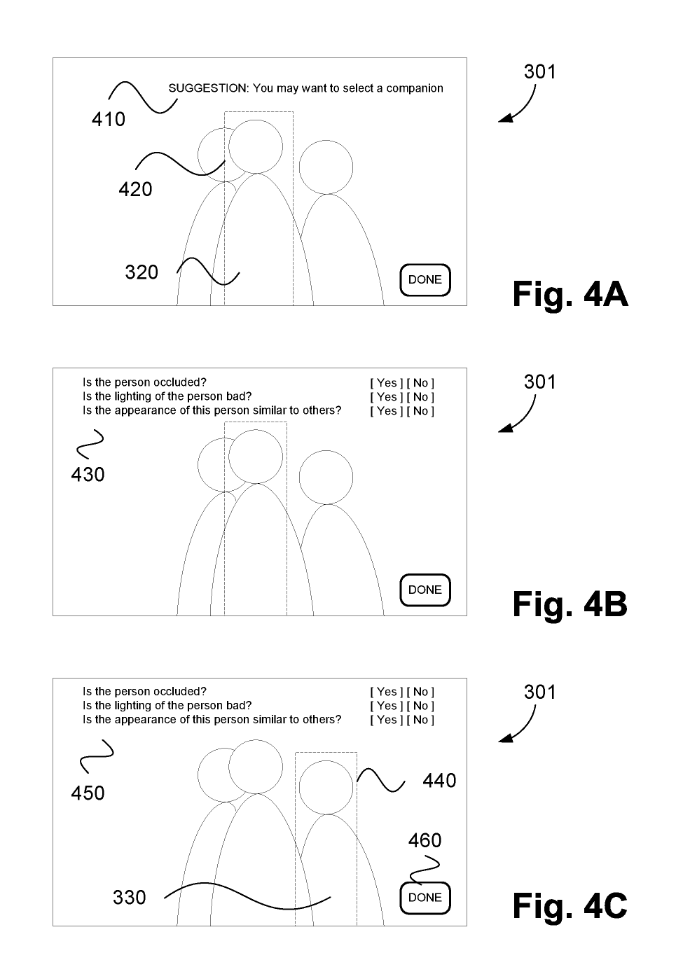

The method 100 may be implemented as one or more software code modules of the software application program 100 resident in the hard disk drive and being controlled in its execution by the processor 105. The method 100 will be described by way of example with reference to FIGS. 3A, 3B, 3C, 4A, 4B and 4C.

The method 100 begins at input step 110, where the probe image containing the probe person and a companion person is received under execution of the processor 805. The probe image may be stored in the memory 806 and be displayed on the display 814. FIG. 3A shows the probe image 301 including the probe person 310 and the probe companion 320. The probe image 301 may be stored in the memory 806 and be displayed on the display 814. The probe person 310 is indicated by bounding box 340 in another instance of the probe image 301 shown in FIG. 3B. The companion 320 is indicated by bounding box 420 in still another instance of the probe image 301 as seen in FIG. 4A. The probe image 301 may be displayed on the display 314 in visual colour. However, the probe image 301 may also be displayed in pseudo-colour (e.g. images from a night vision surveillance system). There may be multiple people captured in the probe image 301 as in the example of FIG. 3A.

The method 100 continues at input step 120, where a gallery image containing multiple people is received under execution of the processor 805. The gallery image may be stored in the memory 806 and be displayed on the display 814. The people in the gallery image may be identified at step 120, under execution of the processor 805, using any suitable person detection method. In one person detection method, the person is detected by performing foreground separation using a statistical background pixel modelling method such as Mixture of Gaussian (MoG), where the background model is maintained over multiple frames of the gallery image. In another person detection method, a foreground separation method is performed on Discrete Cosine Transform blocks. In yet another person detection method, a foreground separation is performed on an unsupervised segmentation of the image, for example, using super-pixels. In yet another person detection method, the persons are detected using a person detector. The person detector, a supervised machine learning method, classifies an image region as containing a person or not based on a set of exemplar images of people. The output of the person detection method is a set of bounding boxes at different locations in the gallery image.

The method 100 continues at determining step 130, where the probe person in the probe image input at step 110 is matched to a person in the gallery image input at step 120. The probe person is matched to the person in the gallery image at step 130 by determining a matching score as will be described in detail below.

The method 100 concludes at output step 140, where a person in the gallery image matching the probe person in the probe image is determined, under execution of the processor 805, if such a match exists.

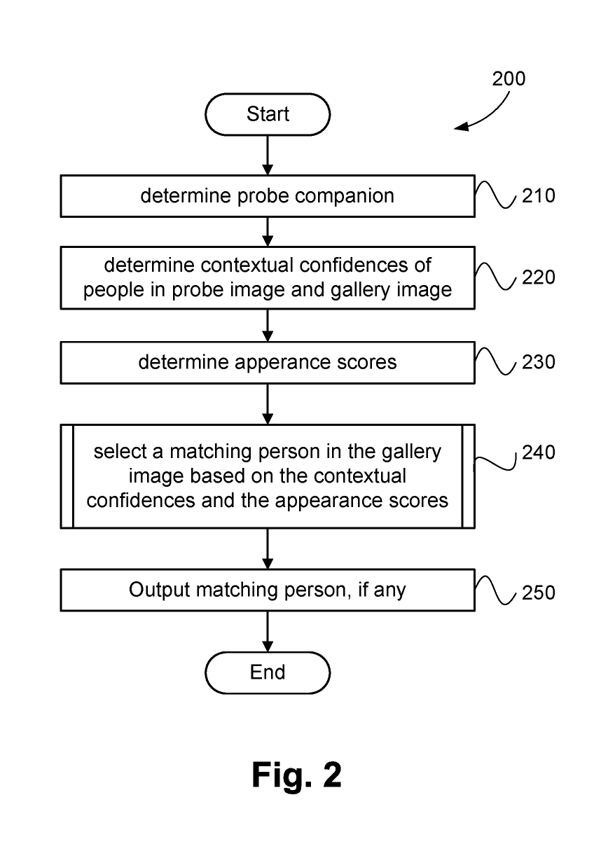

A method 200 of selecting a person in the gallery image who matches the probe person in the probe image, will now be described with reference to FIG. 2. The method 200 may be implemented as one or more software code modules of the software application program 100 resident in the hard disk drive and being controlled in its execution by the processor 105.

The method 200 begins at determining step 210, where a probe companion of the probe person in the probe image is determined, under execution of the processor 805. The probe companion may be determined at step 210 based on user input from an operator through a user interface displayed on the display 814, as will now be described below with reference to FIGS. 3A, 3B, 3C, 4A, 4B and 4C.

FIG. 3A shows the probe image 301 containing three people 310, 320 and 330 in the example probe image 301. FIG. 3B shows the probe image 301 displayed on the display 814 by another instance of the user interface when the user indicates the probe person 301. A bounding box 340 may be drawn around the probe person 310, by the user, to indicate that the person 310 is the probe person. Referring to FIG. 3C, questions 350 are displayed, under execution of the processor 805, in order to determine the contextual confidence of the selected probe person 310. In the example of FIG. 3, the questions are:
“Is the person occluded? (Yes/No)”
“Is the lighting of the person bad? (Yes/No)”
“Is the appearance of this person similar to others? (Yes/No)”

In the example of FIGS. 3A to 3C, the person 310 is occluded. The user answers Yes, No, No to the three questions 350. Based on the answers, it is determined that the probe person is occluded. Referring to FIG. 4A, the user is prompted to select a companion person, by a textual suggestion 410 displayed on the display 314 under execution of the processor 805. As seen in FIG. 4A, the suggestion 410 reads “SUGGESTION: You may want to select a companion”. In response to the suggestion 410, the user draws a bounding box 420, as seen in FIG. 4A, to indicate that the person 320 is a companion. Referring to FIG. 4B, questions 430 regarding the companion are displayed on the display 814, under execution of the processor 805. In the example of FIGS. 4A and 4B, the user answers No, No, No, to the three questions 430. At this point in the example of FIGS. 4A and 4B, the user has already identified a companion who has high contextual confidence. The action of marking bounding box 310, 420, fulfils the input 110.

Referring to FIG. 4C, a DONE button 460 displayed on the image 301 may be selected by a user to indicate that the steps of identifying the probe companion are done. Alternatively, the user may select one more companion 330 using bounding box 440 and answer questions 450 regarding person 330. The action of the user selecting the bounding box 420 (and optionally 440) fulfils the step 210 to determine the probe companion.

The method 200 continues at determining step 220, where the contextual confidences of the probe person 310, the probe companion 320, and the people in the gallery image are determined, under execution of the processor 805. Contextual confidence is a number between zero (0) and one (1). Contextual confidence of the probe person 310 in the probe image 301 is a measure of prediction accuracy of the probe person 310 being re-identified in the gallery image (i.e., a match to probe person 310 being determined in the gallery image). Similarly, contextual confidence of the probe companion 320 in the probe image 301 is a measure of prediction accuracy of the probe companion 320 being re-identified in the gallery image (i.e., a match to probe companion 320 being determined in the gallery image). Let P0 denote the probe person 310. Let there be N probe companions (e.g., 320), denoted by P1, P2 . . . PN. Let there be M people in the gallery images denoted by G1, G2 . . . GM. Let C(P0), C(P1) . . . C(PN), C(G1) . . . C(GM) are used to denote the contextual confidence values of the 1+N+M people.

The contextual confidence of the probe person, C(P0), and the probe companion(s) C(P1) . . . C(PN) may be determined through the answers for the questions 350, 430 . . . etc. For example, an answer of three “No”s may be assigned a contextual confidence of 100%, two “No” answers may be assigned a contextual confidence of 75%, and less than two “No” answers may be assigned a contextual confidence of 25%.

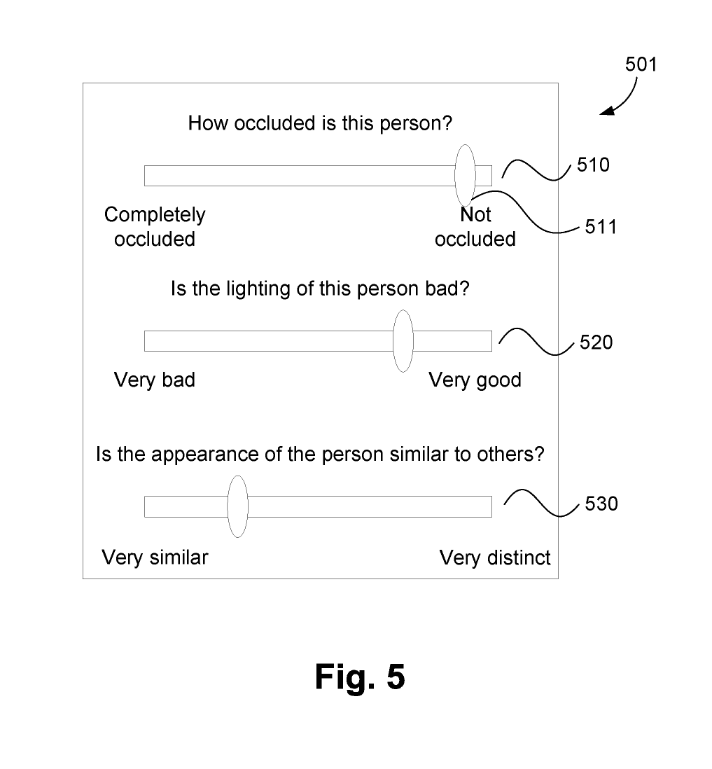

The questions of 350, 430 . . . etc do not need to be limited to a choice between Yes and No. For example, FIG. 5 shows an instance 501 of an example user interface for asking questions to determine the contextual confidence of a person. The question “How occluded is this person?” is associated with slider 510. The slider 510, may be used to indicate an answer by moving indicator 511 along the slider 510. The indicator 511 may be dragged to the leftmost position (position 0), which in the associated question indicates the person is completely occluded. Indicator 511 may be dragged to the rightmost position (position 100), to indicate that the person is not occluded. The initial position of the indicator 511 may be in the middle, or may be from the last used position, or may be defined by a computer algorithm based on a bounding box of a person involved. Let p1, be a value between zero (0) and one hundred (100), is the final position of the indicator after being adjusted by the user.

Similar to slider 510, sliders 520, 530 shown in FIG. 5 provide a user interface for answers to two associated questions. Let p2, p3 denote final positions of the two sliders 520, 530. The contextual confidence of a person may then be determined by values p1, p2, and p3. Contextual confidence may be determined in accordance with Equation (1), below:

Contextual confidence=max((p1+p2+p3)/3,25)% (1)

where max(v1,v2) is a function that returns the larger value of v1 and v2.

The questions asked may be about factors other than occlusion, lighting and similarity. For example, the questions may ask about blurriness, size of the person, portions of the body, and so on.

The contextual confidence of the people in the gallery image C(G1) . . . C(GM) may be determined using a support vector machine (SVM) which is a supervised machine learning algorithm. To determine the contextual confidence of the people in the gallery image C(G1) . . . C(GM), an image of a person is first summarized to an appearance descriptor. One example of an appearance descriptor is a histogram of pixel colours and image gradients within predefined spatial cells of a rectified image. Such an appearance descriptor may be considered mathematically as a point in a very high dimensional space. In the very high dimensional space, there is a predefined hyperplane, which may be calculated using SVM at the training time. The hyperplane segments points into two classes, being points generated from high contextual confidence person image, and points generated from low contextual confidence person image. Points at the hyperplane have a contextual confidence of 50%. The distance of a point away from the hyperplane is an indication of how high (i.e., to a maximum of 100%) or how low (i.e., to a minimum of 0%) the contextual confidence is.

The contextual confidence of the probe person and the probe companions may also be determined by a machine learning algorithm, as described above. Furthermore, the user may adjust the determined contextual confidence of the person to better reflect an understanding of the person in the application of person re-identification. Referring to FIGS. 3A, 3B, 3C, 4A, 4B and 4C, after the user has selected the bounding box 310 for the probe person 310 or the probe companion 320, instead of asking questions 350, 430 regarding the contextual confidence, the abovementioned machine learning algorithm may be executed to determine the contextual confidence of the person in the bounding box 310, 420.

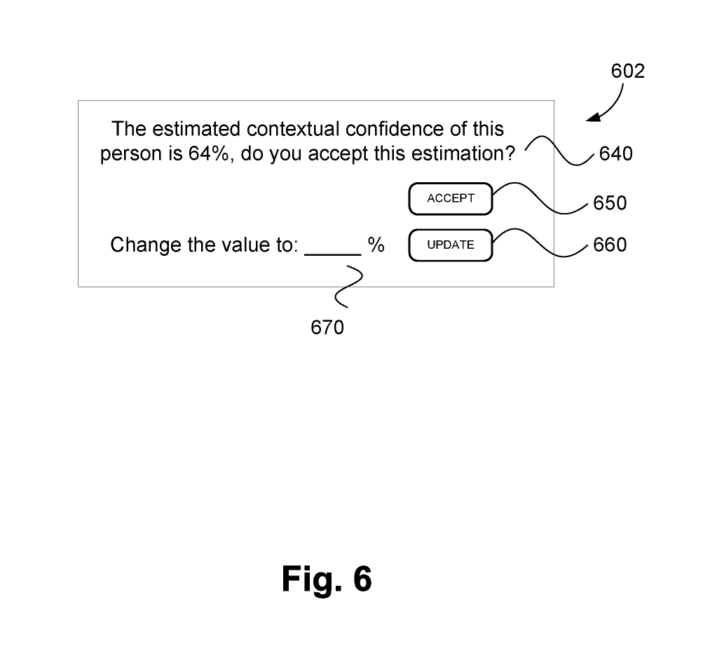

FIG. 6 shows another instance 602 of an example user interface. The instance 602 may be displayed on the display 814 after the user has selected a bounding box of a person, to disclose 640 the determined contextual confidence of the person. The user may then accept 650 the determined value, or the user may update 660 the contextual confidence with a new value 670.

Following step 220, the method 200 continues at determining 230, where appearance scores between each person in the probe image and each person in the gallery image are determined under execution of the processor 805. The appearance score of two people is a measure of the similarity of appearance of the two people. The more similar the appearances of the two people are, the higher the appearance score for the two people. Let S denote the appearance score, for example, S(P1,G1) denote the appearance score of probe image P1 and gallery image G1. If there are N probe companions and M people in the gallery image G1, then there are M×(N+1) appearance scores all together.

To determine the appearance score of two images of people, the first step is to extract appearance descriptors from each of the two images. One example of an appearance descriptor is a histogram of pixel colours and image gradients within predefined spatial cells of a rectified image. Another example of an appearance descriptor is a “bag-of-words” model of quantized keypoint descriptors. The appearance score of two images of people is then determined based on the two appearance descriptors. Many other similarity or dissimilarity scores may be determined to compare two appearance descriptors. One example of a dissimilarity score is a Mahalanobis distance between the appearance descriptors of two objects.

The appearance scores determined at step 230 may be stored in the memory 806. Following step 230, the method 200 continues at selecting step 240, where a matching person in the gallery image is selected based on the contextual confidences and the appearance scores determined in steps 220 and 230. The matching person in the gallery image is selected at step 240 based on a total matching score. A method 700 of selecting a matching person in a gallery image based on a total matching score, as executed at step 240, will be described in detail below.

The method 200 concludes at outputting step 250, where the total matching score determined at step 240 is accessed. If the total matching score is higher than a predetermined threshold, then the matching person selected at step 240 is output, and the probe person is successfully re-identified. If the total matching score is lower than the predetermined threshold, then no one in the gallery image matches the probe person. The predetermined threshold may be determined by observing a distribution of the total matching score of known matched person.

The method 700 of selecting a matching person in a gallery image based on a total matching score, as executed at step 240, will now be described. The method 700 may be implemented as one or more software code modules of the software application program 100 resident in the hard disk drive and being controlled in its execution by the processor 105.

The method 700 begins at determining step 710, where the contextual confidences, C(P0) . . . C(PN) and C(G1) . . . C(GM) and the appearance scores S(P0,G1) . . . S(PN,GM) determined at steps 220 and 230, respectively, are received under execution of the processor 805.

At selecting step 720, one person in the gallery image is selected as a candidate. The term candidate refers to a person in the gallery image that may be the matching person of the probe person. As each person in the gallery image shall take turn to be the candidate, the candidate is selected sequentially starting from G1. Then at determining step 730, a matching score between the probe person and the candidate person is determined under execution of the processor 205. The matching score may be stored in the memory 806. The matching score determined at step 730 may be denoted by MS1. Assume that the kth person in the gallery image, Gk, is the candidate, then matching score, MS1 is determined in accordance with Equation (2), as follows:

MS1=C(P0)×C(Gk)×S(P0,Gk) (2)

The method 700 continues at determining step 740, where a matching score between the probe companion(s) and the other gallery people is determined under execution of the processor 805. The matching score determined at step 740 may be denoted as MS2. In step 740, a one to one assignment between the probe companion(s) and the people (except the candidate) in the gallery image is established, so that the one to one assignment may generate the highest matching score MS2. The establishment of the one to one assignment to generate the highest matching score is known as the assignment problem and may be solved using a suitable algorithm, such as the Hungarian algorithm. The output of the Hungarian algorithm are pairs of people, which may be considered as a set of pairs of indices, {(m(p,1), m(g,1)), (m(p,2),m(g,2), . . . , ). Let P(m(p,j)) and G(m(g,j)) denote the j-th pair of people, which P(m(p,j)) is a probe companion and G(m(g,j)) is a person in the gallery but not the candidate. MS2 is defined in accordance with Equation (3), as follows:

MS2=The summation of {C(P(m(p,j)))×C(G(m(g,j)))×S(P(m(p,j)),G(m(g,j)))} for all pairs j. (3)

At the next determining step [7]50, the total matching score, for the kth person in the gallery image, Gk, being the candidate, is determined. The total matching score may be denoted by TMS(k) and is determined in accordance with Equation (4), as follows:

TMS(k)=MS1+MS2 (4)

If there are more people in the gallery image to be processed at decision step [7]60, a next person in the gallery image is selected as the candidate. Otherwise, the method 700 proceeds to step 770. After each person in the gallery image have had a chance to be the candidate, there are M total matching scores, namely TMS(1), TMS(2) . . . TMS(M).

At outputting step 770, the highest total matching score is determined, and the candidate, Gk, who corresponds to the highest matching score is output. The candidate person, Gk, who corresponds to the highest matching score is the matching person.

The total matching score, TMS(k), depends on MS1, which depends on the contextual confidence C(P0). If the probe has low contextual confidence (e.g. if the probe is occluded, in the dark, or has similar appearances to others), the matching score determined at step 730 MS1 would be low. However, if the probe companion has high contextual confidence, and has a similar appearance with a person in the gallery image, then the matching score MS2 determined at step 740 would have a very high value. So, the total matching score TMS(k) is boosted up, and this enables the described methods to select the candidate person even if the probe person has low contextual confidence.

As described above, at step 740, the matching score, MS2, is determined in accordance with Equation (3) for the assigned pairs of probe companion(s) and the people in the gallery image. Alternatively, the matching scored, MS2, may be determined at step 740 in accordance with Equation (5), as follows:

MS2=The summation of {C(P(m(p,j))*C(G(m(gj)))*S(P(m(p,j)),G(m(g,j)))*D(G(m(g,j))} for all pairs p (5)

where D(G(m(g,j)) is a spatial distance score. The spatial distance score D(G(m(g,j)) increases the matching score MS2 if the gallery person, G(m(g,j)), is spatially close to the candidate person, Gk. The spatial distance score is a reward to indicate that the person G(m(g,j)) is more likely to be a companion of being close to the candidate, and hence is more likely to match a probe companion. Let d denote the spatial distance between person G(m(g,j)) and Gk. For a surveillance camera that could derive the physical position of people in the gallery image, the spatial distance, d, is the physical distance between person G(m(g,j)) and Gk in the unit of metres. For other cameras that could not derive the physical position of the people in the gallery image, the spatial distance, d, is the pixel distances between the centroid of the bounding box of G(m(g,j)), and the centroid of the bounding box of Gk, in the unit of pixel. The spatial distance score may be determined in accordance with Equation (6), as follows:

D(G(m(g,j))=exp(−s*d) (6)

where exp( ) is the exponential function and s is a predefined scalar to cater for the scale of different cameras. 0<D(G(m(g,j))<=1.

### INDUSTRIAL APPLICABILITY

The arrangements described are applicable to the computer and data processing industries and particularly for image processing.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of matching a first person in a first image to a person in a second image, the method comprising:
determining at least one companion in the first image, the companion being one of a plurality of people in the first image and being different to the first person;
determining a contextual confidence for the first person, the companion and each of a plurality of people in the second image, the contextual confidence being a measure of prediction accuracy of a match to the first person;
determining an appearance score between each person in the first image and each of the plurality of people in the second image, the appearance score measuring similarity of appearance; and
selecting from the plurality of people in the second image, a match for the first person and, based on the match for the first person, a match for the companion, each of the matches being determined according to the contextual confidence and appearance score.

2. The method according to claim 1, wherein the contextual confidence of a person in an image is determined from lighting conditions of the person.

3. The method according to claim 1, wherein the contextual confidence of a person in an image is determined from occlusion of the person.

4. The method according to claim 1, wherein the contextual confidence of a person in an image is determined from appearance related to the person.

5. The method according to claim 1, wherein the match is selected based on spatial distances between a plurality of people in the second image and a candidate person in the second image.

6. The method according to claim 1, wherein the first person and the companion in the first image are indicated by a bounding box.

7. The method according to claim 1, wherein the contextual confidence for the first person and the companion in the first image are determined based on one or more user answers.

8. The method according to claim 7, wherein the user answers are based on one or more of occlusion, lighting, similarity, blurriness, size and portions of a body.

9. The method according to claim 7, wherein the user answers are indicated by a slider.

10. An apparatus for matching a first person in a first image to a person in a second image, the apparatus comprising:
means for determining at least one companion in the first image, the companion being one of a plurality of people in the first image and being different to the first person;
means for determining a contextual confidence for the first person, the companion and each of a plurality of people in the second image, the contextual confidence being a measure of confidence of a match to the first person;
means for determining an appearance score between each person in the first image and each of the plurality of people in the second image, the appearance score measuring similarity of appearance; and
means for selecting from the plurality of people in the second image, a match for the first person and, based on the match for the first person, a match for the companion, each of the matches being determined according to the contextual confidence and appearance score.

11. A system for matching a first person in a first image to a person in a second image, the system comprising:
a memory for storing data and a computer program;
a processor coupled to the memory for executing the computer program, the computer program having instructions for:
determining at least one companion in the first image, the companion being one of a plurality of people in the first image and being different to the first person;
determining a contextual confidence for the first person, the companion and each of a plurality of people in the second image, the contextual confidence being a measure of confidence of a match to the first person;
determining an appearance score between each person in the first image and each of the plurality of people in the second image, the appearance score measuring similarity of appearance; and
selecting from the plurality of people in the second image, a match for the first person and, based on the match for the first person, a match for the companion, each of the matches being determined according to the contextual confidence and appearance score.

12. A non-transitory computer readable medium having program stored on the medium for matching a first person in a first image to a person in a second image, the program comprising:
code for determining at least one companion in the first image, the companion being one of a plurality of people in the first image and being different to the first person;
code for determining a contextual confidence for the first person, the companion and each of a plurality of people in the second image, the contextual confidence being a measure of confidence of a match to the first person;
code for determining an appearance score between each person in the first image and each of the plurality of people in the second image, the appearance score measuring similarity of appearance; and
code for selecting from the plurality of people in the second image, a match for the first person and, based on the match for the first person, a match for the companion, each of the matches being determined according to the contextual confidence and appearance score.
